(19) United States
(12) Patent Application Publication
(10) Pub. No.: US 2004/0159509 A1
(43) Pub. Date: Aug. 19, 2004

(54) Dual bore electric caliper with taper wear adjustment

(75) Inventors: Huang-Tsang Chang, Dayton, OH (US); Eric Padiolleau, Compiegne (FR)

Correspondence Address: Scott A. McBain, Esq., Delphi Technologies Inc., Legal Staff, Mail Code 480-414-420, P.O. Box 5052, Troy, MI, 48007-5052, US

(73) Assignee: Delphi Technologies, Inc.

(21) Appl. No.: 10/367,392

(22) Filed: Feb. 14, 2003

(51) Int. Cl. F16D 65/36

(52) U.S. Cl. 188/156; 188/72.7

(57) ABSTRACT

An electric caliper having a housing mounted adjacent a rotatable disc. First and second force applying elements support a friction element between the housing and the rotatable disc. An electric actuator is mounted in the housing and is operatively connected to the first and second force applying elements. The electric actuator is operable to move the first and second force applying elements and the friction element toward, and away from, the disc and cause the friction element to frictionally contact the disc. A method is also provided for applying first and second forces against a friction element in response to an operation of an electric motor. The first and second forces are applied with respective magnitudes so as to maintain a substantially constant wear between the edges of the first friction element.

### TECHNICAL FIELD

This invention relates generally to vehicle brakes and more particularly, to an apparatus and method for an electric caliper brake.

### BACKGROUND OF THE INVENTION

Various types of brake systems are commonly used in vehicles, including hydraulic, anti-lock, also referred to as ABS, and electric, also referred to as “brake by wire.” For example, in a hydraulic brake system, the hydraulic fluid transfers energy from a brake pedal to a brake pad for slowing down or stopping rotation of a wheel of the vehicle. Electronics control the hydraulic fluid in the hydraulic brake system. In the electric brake system, the hydraulic fluid is eliminated. Instead, an electric caliper controls the application and release of the brake pad.

Known electric calipers often use an electric motor to drive a ballscrew that in turn advances and retracts a nut connected to a friction brake pad. One example of a known electric caliper is illustrated in FIGS. 5 and 6. To operate an electric caliper 16 within a brake 18, a force is applied to a brake pedal (not shown) to initiate operation of an electric motor 20 within a bore 21 of a housing 22. The motor 20 is connected to a gear drive 24 comprising, for example, a pinion gear 26, planetary gears 28 and ring gear 30. The rotation of the motor 20 and pinion gear 26 moves the axes of the planetary gears 28 about a circular path within the ring gear 30 with respect to a centerline 31 of the bore 21. The axes of the planetary gears 28 are mechanically connected to a screw portion 32 of a ballscrew 34; and thus, motion of the axes of the planetary gears in the circular path provides a rotation of the screw portion 32. Rotation of the screw 32 causes a ballscrew nut 36 and attached piston 40 to move linearly with respect to the centerline of the housing bore 21, for example, out of the bore 21 away from the housing 22, that is, from right to left as viewed in FIG. 5. The displacement of the piston 40 engages an inner brake pad 42 with one side of a disc or rotor 44 mechanically connected to a wheel (not shown). The resulting pressure that builds up from forcing the inner brake pad 42 against the disc 44 creates a reactionary force 46. The reactionary force 46 is transmitted back into the housing 22 through a rod (not shown) and into a thrust bearing (not shown) in a known manner. The housing 22 is displaced in the direction away from the disc 44, that is, from left to right as viewed in FIG. 5; and a housing bridge 47 pulls the outer brake pad 48 toward an opposite side of the disc 44, until both the inner brake pad 42 and outer brake pad 48 are exerting pressure on the disc 44 to slow down or stop the rotation of the wheel. An electric caliper as described above is more fully described in U.S. Pat. No. 6,139,460 entitled “Electric Caliper”, which is hereby incorporated in its entirety by reference herein.

Referring to FIG. 7, assume the disc 44 is normally rotating in a clockwise direction as viewed from the pad 42 as indicated by the arrow 49, as the brake pads 42, 48 are applied against the disc 44, the rotation of the disc 44 results in slightly greater forces being applied at leading edges 37 of pads 42, 48 than the forces being applied at respective trailing edges 38. Consequently, over time, the brake pads 42, 48 will experience slightly greater wear at their respective leading edges than at their respective trailing edges. The result is a tapered wear pattern across respective faces of the brake pads 42, 48 as indicated by the dashed lines 39. Such an uneven wear pattern reduces the useful life of the brake pads 42, 48.

Therefore, there is a need for an electric caliper braking system that provides a more uniform application of forces across the face of the brake pad.

### SUMMARY OF THE INVENTION

The present invention provides an electric caliper that provides more uniform pattern of brake pad wear than current systems and extends the useful life of brake pads. The electric caliper of the present invention allows fine tuning of the brake pad leading edge and trailing edge taper wear performance. Further, the electric caliper of the present invention provides significant design flexibility, and such electric calipers can be provided over a greater range of vehicle applications.

According to the principles of the present invention and in accordance with the described embodiments, the invention provides an electric caliper for a brake system. The electric caliper has a housing mounted adjacent a rotatable disc and first and second force applying elements supporting a friction element between the housing and the rotatable disc. An electric actuator is mounted in the housing and is operatively connected to the first and second force applying elements. The electric actuator is operable to move the first and second force applying elements and the friction element toward, and away from, the disc and cause the friction element to frictionally contact the disc. By applying forces at two different locations on the disc, the two forces are able to compensate for the nonuniform forces on the friction element that arise from the direction of rotation of the disc, thereby providing a more uniform wear pattern on the friction element.

In one aspect of this invention, the housing has first and second bores; and the electric actuator includes an electric motor mounted in the housing. The electric actuator further includes first and second rotary-to-linear motion converters disposed in the first and second bores, respectively. The rotary-to-linear motion converters are connected between the electric motor and respective first force applying elements to linearly move the respective force applying elements in response to a rotation of the electric motor.

In another embodiment of the invention, a method is provided for operating an electric caliper for a brake system having a rotatable disc. The caliper has a pair of opposed friction elements supported by a caliper housing, wherein each of the friction elements is disposed on, and movable with respect to, a different side of the disc. The method applies first and second forces against a first friction element in response to an operation of an electric motor.

In an aspect of this invention, the first force is applied adjacent one edge of the first friction element; and the second force is applied adjacent another edge of the first friction element. The first and second forces are applied with respective magnitudes so as to maintain a substantially constant wear between the edges of the first friction element.

These and other objects and advantages of the present invention will become more readily apparent during the following detailed description taken in conjunction with the drawings herein.

### BRIEF DESCRIPTION OF THE DRAWINGS

FIG. 1 is a partially cross-sectioned top view of one embodiment of an electric caliper in accordance with the principles of the present invention.

FIG. 2 is a partially cross-sectioned end view of the electric caliper of FIG. 1 in which other parts of the brake are not shown.

FIG. 3 is a partially cross-sectioned top view of another embodiment of an electric caliper in accordance with the principles of the present invention.

FIG. 4 is a partially cross-sectioned end view of the electric caliper of FIG. 3 in which other parts of the brake are not shown.

FIG. 5 is a partially cross-sectioned side view of a known electric caliper.

FIG. 6 is a partially cross-sectioned end view of the electric caliper of FIG. 5.

FIG. 7 is a schematic top view of the disc and brake pads of the electric caliper of FIG. 5 illustrating a tapered wear pattern on the brake pads.

### DETAILED DESCRIPTION

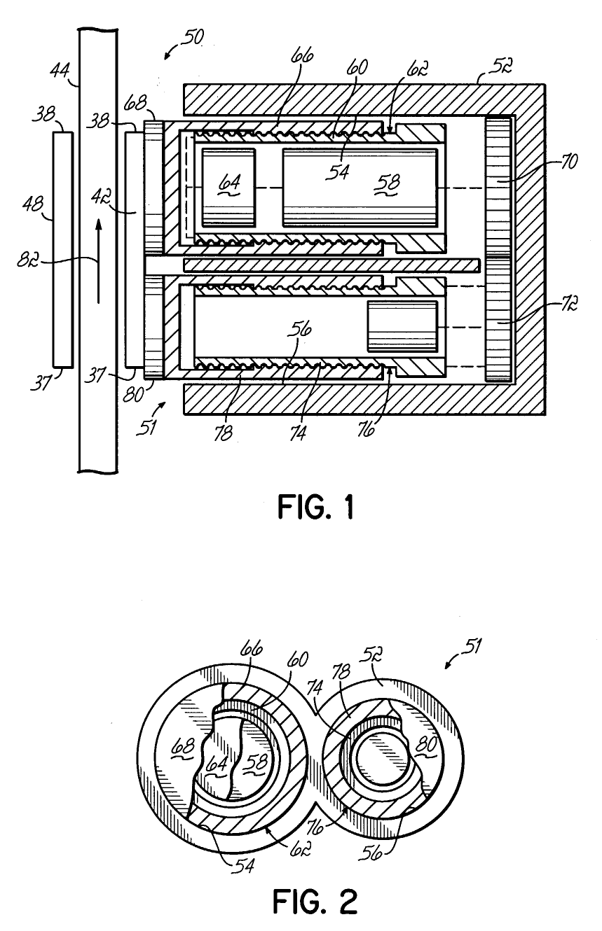

Referring to FIGS. 1 and 2, a brake 50 includes an electric caliper 51 that has a caliper housing 52 with first and second bores 54, 56, respectively, therein. Rotary-to-linear motion converters, for example, first and second ballscrews 62, 76, are disposed in the respective bores 54, 56. An electric motor 58 is located in the first bore 54 and has an output shaft mechanically connected to a gear box 64 that is used to provide a mechanical advantage to the motor 58. A nut portion 66 of the ballscrew 62 supports a first force applying element, for example, piston 68, that contacts the inner pad 42. Thus, operation of the motor 58 causes the ball nut 66 to move linearly with respect to a centerline of the housing bore 54, for example, out of the bore 54, that is, from right to left as viewed in FIG. 1, to force the inner pad 42 against the rotating disc 44. In a manner as previously described, motion of the inner pad 42 against one side of the disc 44 causes the outer pad 48 to move toward the opposite side of the disc 44, that is, from left to right as viewed in FIG. 1. Thus, that action of the ball nut 66 results in braking forces being applied by the inner and outer pads 42, 48 against the rotating disc 44.

The output shaft of the motor 58 is also mechanically connected to a first gear 70 that meshes with a second gear 72. The gear 72 is mechanically connected to a screw portion 74 of a second ballscrew 76. The nut portion 78 of the second ballscrew 76 supports a second force applying element, for example, a piston 80, that also contacts the inner brake pad 42. Thus, rotation of the motor 58 rotates the gears 70, 72 and the screw 74. Rotation of the screw 74 causes the nut 78 to move linearly with respect to a centerline of the housing bore 56, for example, out of the second bore 56 toward the inner pad 42, that is, from right to left as viewed in FIG. 1.

Thus, operation of the motor 58 results in both ball nuts 66, 78 moving in unison out of the bore 56 and jointly forcing their respective pistons 68, 80 against the inner brake pad 42. Assume the disc 44 is rotating in a clockwise direction as viewed from the brake pad 42 and indicated by the arrow 82. Piston 80 is applying a braking force near leading edges 37 of the respective brake pads 42, 48; and the piston 68 is applying brake forces near trailing edges 38 of the respective brake pads 42, 48.

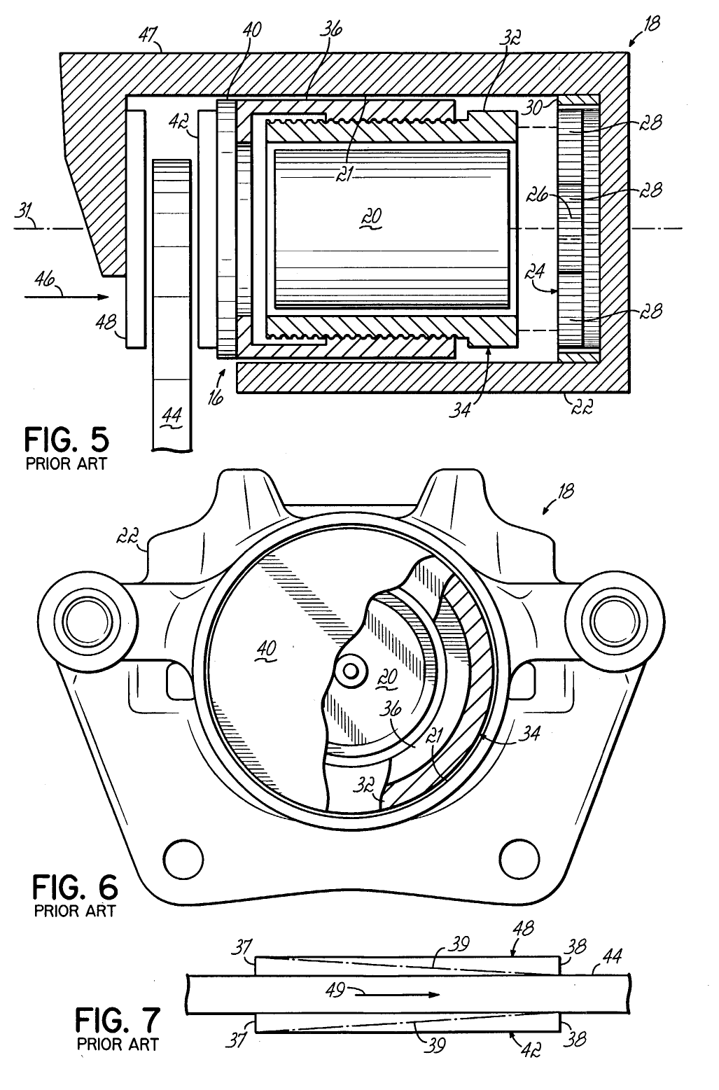

With the known braking system of FIGS. 5 and 6, the braking force is applied substantially at the centerline of the pads 42, 48. However, with the embodiment of FIG. 1, by utilizing a dual bore caliper 50 providing two force applying pistons 68, 80, the point at which the net force is applied can be shifted from the centerline of the brake pads 42, 48 toward their respective trailing edges 38. Such a proportioning or shifting of the net force on the pads 42, 48 is accomplished by adjusting the gear ratio of the gears 70, 72 and the pitch of the ballscrews 62, 76. For example, as operation of the motor 58 causes the piston 68 to move through a first displacement, the gear ratio of the gear 70, 72 can be chosen such that the piston 80 moves through a slightly smaller or slightly greater displacement. Most often, the gear ratio 70, 72 is chosen such that the piston 68 applies a greater force near the trailing edges 38 of the pads 42, 48. That greater force is used to compensate for the greater force that is provided at the leading edges 37 as a result of the direction of rotation of the disc 44, in this example, the clockwise rotation.

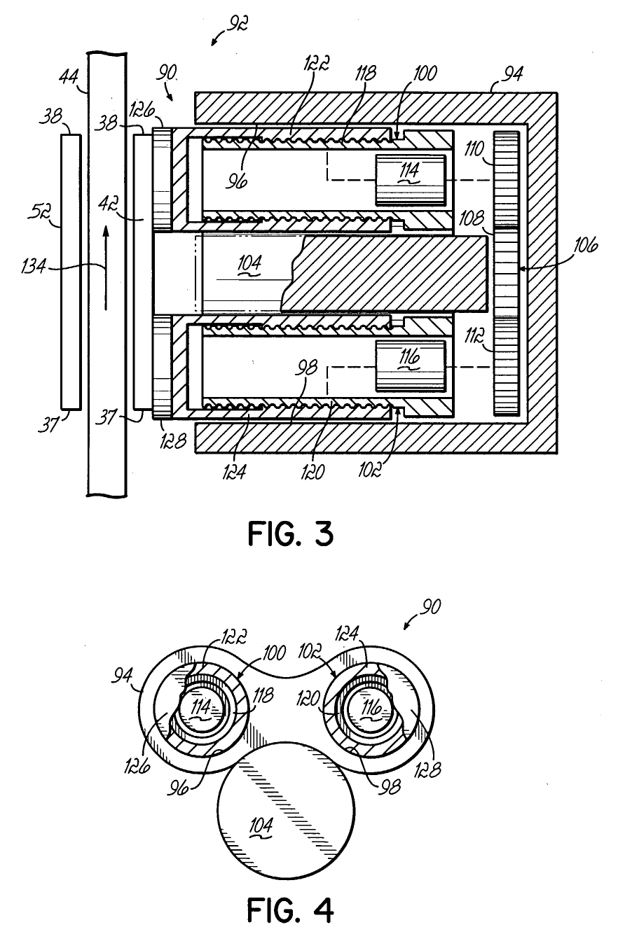

FIGS. 3 and 4 illustrate an alternative embodiment of an electric caliper that provides a more even wear of the brake pads 42, 48 than the known system of FIG. 1. An electric caliper 90 of a brake 92 has a housing 94 with first and second bores 96, 98 that house rotary-to-linear motion converters, for example, first and second ballscrews 100, 102. An electric motor 104 is supported by the housing 94 and has an output mechanically connected to a gear train 106 comprised of a drive gear 108, a first gear 110 and a second gear 112. The first and second gears 110, 112 are connected to respective first and second gear boxes 114, 116. The first and second gear boxes 114, 116 are mechanically connected to respective first and second screw portions 118, 120 of the respective first and second ballscrews 100, 102. The first and second ballscrews 100, 102 have respective ball nuts 122, 124 that support respective force applying elements, for example, pistons 126, 128, respectively, that contact the inner brake pad 42.

Operation of the motor 104 rotates the gears 108-112 and screws 118, 120 via gear boxes 114, 116. Rotation of the screws 118, 120 causes respective ball nuts 122, 124 and pistons 126, 128 to move linearly with respect to a centerline of the housing bore 96, for example, out of the bore 96, that is, from right to left as viewed in FIG. 3. Moving the pistons 126, 128 out of the housing bore 96 forces the inner pad 42 against one side of the rotating disc 44. That motion of the inner pad against the disc causes the outer pad 48 to move toward an opposite side of the disc 44 in a manner as previously described, thereby causing the brake pads 42, 48 to apply braking forces against the rotating disc 44.

In this embodiment, the point at which the net force is applied to the brake pads 42, 48 can be shifted from a centerline of the brake pads 42, 48 to a location closer to the trailing edges 38 of the respective pads 42, 48. The distribution of the braking force across the pads 42, 48 is controlled by adjusting the gear ratio of the gear mechanisms 106, 114, 116 and the pitch of the ballscrews 100, 102. The gear ratios are chosen such that a greater force is applied by the piston 126 with respect to the forces applied by the piston 128. That greater force compensates for the inherently greater force inherently occurring at the leading edges 37 of the respective pads 42, 48 in response to a clockwise rotation of the disc 44 as indicated by the arrow 134.

In use, with the embodiments of FIGS. 1-4, with each use of the brakes, the braking forces are distributed over the brake pads 42, 48 in a controlled manner, such that the wear pattern of the brake pads 42, 48 can be controlled and made more uniform. The multi-bore electric calipers described herein allow fine tuning of the brake pad leading edge and trailing edge taper wear performance. With a more uniform, that is, a more linear and less tapered, wear pattern on the brake pads 42, 48, the useful life of the brake pads 42, 48 is substantially lengthened, thereby providing a higher quality and less costly braking system. Further, the multi-bore electric caliper described herein provides significant design flexibility. For example, the ability of the multi-bore electric caliper to control the force distribution across the brake pad allows the use of commercially available motors and ballscrews. In addition, the calipers can be designed and applied over a wide range of vehicle applications.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. For example, in the embodiment of FIGS. 1 and 2, the motor 58 is mechanically connected to the screw portion 60 of the ballscrew 62 via a gear box 64. As will be appreciated, in an alternative embodiment, the motor 58 can be directly coupled to the screw portion 62 without using the intervening gear box 64. Similarly, in the embodiment of FIGS. 3 and 4, the motor 104 is mechanically connected to the screw portions 118, 120 via respective gear boxes 114, 116. However, as will be appreciated in alternative embodiments, the gear boxes 114, 116 can be eliminated and the screw portions connected more directly to the motor 104 via the gear train 106.

In all of the described embodiments, a motor is mechanically connected to a rotatable, but non-translatable, screw portion of a respective ballscrew; and a respective nut that supports a force applying piston translates along the screw in response to the motor rotating the screw. As will be appreciated, in alternative embodiments, the motor can be mechanically connected to a rotatable, but non-translatable, nut of a ballscrew; and a respective screw portion is used to support a piston. In that embodiment, the screw portion translates with respect to the nut in response to the motor rotating the nut.

As will be also be appreciated, although the rotary-to-linear motion converters are described as ballscrews, other varieties of screw and nut combinations may be used. Further, other rotary-to-linear motion converters may be used in place of the ballscrews. In addition, the combinations of electric motors and respective rotary-to-linear motion converters used to operate pistons 68, 80, 126, 128 can be replaced by other electric power actuators, for example, piezoelectric actuators, etc. Also, in the examples described herein, the electric calipers have two bores; however, as will be appreciated, in some applications, it may be necessary to employ more than two bores with respective rotary-to-linear motion converters in order to achieve a desired brake pad wear performance and profile.

As will further be appreciated, in other alternative embodiments, the gear boxes 64, 114, 116 and gear train 106 can be replaced by any other power transmitting mechanism that is effective to transfer rotational power from a motor and rotate a screw portion of a respective ballscrew.

Therefore, the invention in its broadest aspects is not limited to the specific details shown and described. Consequently, departures may be made from the details described herein without departing from the spirit and scope of the claims, which follow.

1. An electric caliper for a brake system having a rotatable disc comprising:
a housing mounted adjacent the disc;
a friction element disposed adjacent one side of the disc and being movable toward, and away from, the disc;
first and second force applying elements supporting the friction element adjacent the housing; and
an electric actuator mounted in the housing and operatively connected to the first and second force applying elements, the electric actuator being operable to move the first and second force applying elements and the friction element toward, and away from, the disc and cause the friction element to frictionally contact the disc.

2. The electric caliper of claim 1 wherein the housing has first and second bores.

3. The electric caliper of claim 2 wherein the electric actuator comprises:
an electric motor mounted in the housing;
a first rotary-to-linear motion converter disposed in the first bore and connected between the electric motor and the first force applying element to linearly move the first force applying element in response to a rotation of the electric motor; and
a second rotary-to-linear motion converter disposed in the second bore and connected between the electric motor and the second force applying element to linearly move the first force applying element in response to a rotation of the electric motor.

4. The electric caliper of claim 3 wherein the electric motor is disposed in the first bore with the first rotary-to-linear motion converter.

5. The electric caliper of claim 3 wherein each of the first and second rotary-to-linear motion converters is a ballscrew.

6. The electric caliper of claim 3 wherein each of the first and second force applying elements is a piston.

7. An electric caliper for a brake system having a rotatable disc comprising:
a housing having first and second bores;
a pair of opposed friction elements supported by the housing, each of the friction elements adapted to be disposed on a different side of the disc, a first friction element being movable toward and away from the disc;
an electric motor disposed in the first bore;
a first ballscrew disposed in the first bore and operatively connected to the motor, the first ballscrew being in mechanical communication with the first friction element; and
a second ballscrew disposed in the second bore and operatively connected to the motor, the second ballscrew being in mechanical communication with the first friction element, the first ballscrew and the second ballscrew being operable to apply respective forces on the first friction element in response to operation of the motor and cause the first friction element to contact the disc.

8. The electric caliper of claim 7 wherein the first friction element comprises:
a leading edge being a first edge encountered by a point on the disc when rotating in a first angular direction; and
a trailing edge being a second edge encountered by the point on the disc when rotating in the first angular direction.

9. The electric caliper of claim 8 wherein the first bore and first ballscrew are disposed adjacent the leading edge of the first friction element and second bore and second ballscrew are disposed adjacent the trailing edge of the first friction element.

10. The electric caliper of claim 9 wherein the second ballscrew applies a force adjacent the trailing edge having a magnitude greater than a force applied by the first ballscrew adjacent the leading edge.

11. The electric caliper of claim 10 wherein the second ballscrew applies a force adjacent the trailing edge sufficiently greater in magnitude than a force applied by the first ballscrew adjacent the leading edge so as to maintain a substantially constant wear of the first friction element between the leading and trailing edges.

12. The electric caliper of claim 11 further comprises:
a first mechanical coupling between the motor and the first ballscrew to apply a first force adjacent the leading edge of the first friction element; and
a second mechanical coupling between the motor and the second ballscrew to apply a second force adjacent the trailing edge of the first friction element, the second force being sufficiently greater than the first force so as to maintain a substantially constant wear of the first friction element between the leading and trailing edges.

13. The electric caliper of claim 7 further comprising a first piston connected between the first ballscrew and the first friction element.

14. The electric caliper of claim 13 further comprising a second piston connected between the second ballscrew and the first friction element.

15. An electric caliper for a brake system having a rotatable disc comprising:
a housing having first and second bores;
a pair of opposed friction elements supported by the housing, each of the friction elements adapted to be disposed on a different side of the disc, a first friction element being movable with respect to the disc;
an electric motor mounted in the housing;
a first rotary-to-linear motion converter disposed in the first bore and having a first translatable element, the first translatable element being movable and in mechanical communication with the first friction element; and
a second rotary-to-linear motion converter disposed in the second bore and having a second translatable element, the second translatable element being movable and operatively connected to the motor, the second translatable element being in mechanical communication with the first friction element, the first translatable element and the second translatable element being operable to apply respective forces on the first friction element in response to operation of the motor and cause the first friction element to contact the disc.

16. The electric caliper of claim 15 wherein the first rotary-to-linear motion converter comprises a first ballscrew and the first translatable element comprises a first nut threadedly coupled to a first screw.

17. The electric caliper of claim 16 wherein the second rotary-to-linear motion converter comprises a second ballscrew and the second translatable element comprises a second nut threadedly coupled to a second screw.

18. The electric caliper of claim 17 further comprising gears connecting the first screw to the motor.

19. The electric caliper of claim 18 further comprising a planetary gear system connecting the first rotatable element and the motor.

20. The electric caliper of claim 17 wherein the second screw is connected to the motor.

21. The electric caliper of claim 20 further comprising gears connecting the second screw to the motor.

22. The electric caliper of claim 17 wherein the electric motor is disposed in the first bore with the first rotary-to-linear motion converter.

23. A method of operating an electric caliper for a brake system having a rotatable disc, the caliper having a pair of opposed friction elements supported by a caliper housing, each of the friction elements being disposed on, and movable with respect to, a different side of the disc, the method comprising:
applying a first force against a first friction element, the first force being created in response to an operation of an electric motor;
applying a second force against the first friction elements, the second force being created in response to the operation of the electric motor.

24. The method of claim 23 further comprising:
applying the first force adjacent one edge of the first friction element; and
applying the second force adjacent another edge of the first friction element.

25. The method of claim 24 further comprising applying the first and second forces with respective magnitudes so as to maintain a substantially constant wear between the edges of the first friction element.

26. The method of claim 25 wherein a leading edge of the first friction element is a first edge encountered by a point on the disc when rotating in a first angular direction and a trailing edge of the first friction element is a second edge encountered by the point on the disc when rotating in the first angular direction, the method further comprising:
applying the first force having a first magnitude adjacent the leading edge of the first friction element; and
simultaneously applying the second force having a magnitude greater than the first magnitude adjacent the trailing edge of the first friction element.

27. The method of claim 26 further comprising simultaneously applying the second force adjacent the trailing edge with a magnitude sufficiently greater than the first magnitude so as to maintain a substantially constant wear between the lateral edges of the first friction element.

28. The method of claim 23 further comprising simultaneously applying the first force and the second force against the first friction element.
